(19) United States
(12) Patent Application Publication
(10) Pub. No.: US 2015/0377457 A1
(43) Pub. Date: Dec. 31, 2015

(54) Adjustable two bulb lamp adapter

(71) Applicant: Paul Abell Barry, Louisville, KY (US)

(72) Inventor: Paul Abell Barry, Louisville, KY (US)

(21) Appl. No.: 14/755,282

(22) Filed: Jun. 30, 2015

Related U.S. Application Data
(60) Provisional application No. 61/998,469, filed on Jun. 30, 2014.

(51) Int. Cl. F21V 19/02; F21V 21/30; F21V 19/00

(52) U.S. Cl. CPC F21V 19/02; F21V 19/0065; F21V 21/30

(57) ABSTRACT

This adjustable two bulb lamp adapter is an electrical device with a male threaded light bulb type base to permit use of two low energy CFL bulbs in place of and function as a three-way incandescent light bulb in existing shade lamps. The adapter embodies two bulb holders with limited and independent rotational adjustment in a plane parallel to the axis of the threaded base. An integral thumb wheel permits rotating and securing the adapter base into the receiving socket while the two bulbs are held in a fixed position. An included adjuster allows utilization as a two bulb adapter for a single filament bulb type socket. These adjustments provide means to optimize fit and light distribution in existing lamp shades and other applications. The concept of using the adapter's adjustable two bulb sockets greatly enhances selecting lower energy CFL bulbs to achieve higher levels of illumination in more applications than available in fixed adapters.

This application claims priority from U.S. Provisional application No. 61/998,469 filed on Jun. 30, 2014

### BACKGROUND

This invention fills the need for an adapter to provide to the ubiquitous three-way incandescent lamp holder a means to allow replacement of a two filament incandescent electric light bulb with an electrical device containing two separate adjustable light bulb holders permitting continued use of the existing four position switching mechanism to function as a three-way lamp holder. The higher energy consumption of the three-way incandescent light bulb can be replaced by two energy efficient Compact Fluorescent Light (CFL) bulbs with the same three-way functioning and thus eliminate the need to replace the higher cost three-way CFL if one level fails. Other two bulb adapters are available however mechanisms are not being supplied to adjust the adapter to the three-way switching means in the widely used four position switched lamp holder. This invention can also be adjusted for use in a single filament type lamp socket for improving light intensity by using two CFL bulbs. This invention embodies rotating sockets and rotating base which improve over existing two bulb adapters by permitting configuration adjustments to accommodate the confinements encountered in lamp shade shapes and mounting hardware. These features allow positioning bulbs to provide optimum directing for lighting needs.

### BRIEF SUMMARY OF THE INVENTION

1. A two bulb holder lamp adapter with each holder separated for independent rotation, closely positioned near the male screw base and with electrical connections to allow each bulb holder limited rotation in a plane parallel or nearly parallel to the axis of the adapter base threads. With the invention positioned in a normal upright attitude, this feature allows each of the two bulb holders to be independently rotated to positions from vertical to below horizontal to achieve optimum distribution of lighting effects from the two bulbs and to be positioned if necessary to avoid possible interferences to any original lamp hardware. The invention adapter may be installed in any position corresponding to the required positioning of the receiving bulb socket. This provision will also permit positioning of each bulb to achieve optimum clearance between an existing shade and the bulb for heat related safety concerns.

2. A two bulb holder lamp adapter fitted with a male screw base shaped to replicate the electrical contact elements of a two filament light bulb base and incorporated therein with electrical provisions for an adjustable shunt for selecting, prior to installation, the current path to cause the invention adapter to operate as a two filament bulb with two separate single filament bulbs installed. This arrangement allows each separate single filament bulb to replace each separate filament of a two filament light bulb. The same shunt can also be adjusted to a current path to permit the adapter to operate the two single filament bulbs both “on” or “off” simultaneously when installed in a conventional lamp holder with a two position switch normally used for single filament light bulb operation or installed in a lamp holder with a four position switch normally for a two filament light bulb operation. A simple single pole electric switch to permit the aforementioned functions can be substituted for the adjustable shunt by installing said switch at at some location selected away from the male screw base.

3. A two bulb holder lamp adapter with a single male screw base fitted with electrically conducting metal collector rings and contactors to permit the invention lamp adapter to be installed into an existing lamp holder by turning an integral insulated “thumb wheel” attached to the conducting screw threads of the adapter base. This feature allows the invention adapter to be installed into electrical connection while the position of the two bulb holders can held in a preselected location . This improvement permits installation of the invention adapter into confined spaces such as would be encountered in a lamp holder containing a shade with a harp type support in place. With these provisions the two bulb unit can also be rotated in a carousel fashion in a plane located at or near 90 degrees to the axis of the adapter base threads with no stop limits required and locked into final position by tightening the “thumb wheel”.

4. The provision of a spring loaded device on the supporting mechanism of the rotatable bulb holder is incorporated to offer adequate rotational resistance to allow each bulb holder to be adjusted to position without the need for an added locking-unlocking device to be operated by the user installer.

### BRIEF DESCRIPTION OF THE DRAWINGS

FIG. 1. FIG. 1 is a side view of the two bulb holder lamp adapter showing the screw base and a partial cross section of one bulb holder with rotating mechanism and an external view of the opposed second bulb holder.

FIG. 2. FIG. 2 is the top exterior view of lamp adapter shown in FIG. 1.

FIG. 3. FIG. 3 is the right side exterior view of lamp adapter shown in FIG. 1.

FIG. 4. FIG. 4 is a cross sectional view of the adapter screw base showing details of electrical embodiments allowing independent rotation of the screw portion of the base during installation and removal of invention.

FIG. 5. FIG. 5 is a view of lamp adapter shown in FIG. 3 with CFL bulbs installed and one bulb holder positioned vertically and the other rotated below horizontal.

FIG. 6. FIG. 6 is view of lamp adapter shown in FIG. 3 with CFL bulbs installed and both bulb holders rotated below horizontal.

FIG. 7. FIG. 7 is a view of lamp adapter shown in FIG. 3 with CFL bulbs installed and both bulb holders rotated to the horizontal position.

FIG. 8. FIG. 8 is a view of lamp adapter shown in FIG. 3 with CFL bulbs installed and both bulb holders rotated to positions between vertical and horizontal.

FIG. 9. FIG. 9 is an isometric view of the lamp adapter incorporating two bulb holders of the design similar to Part 3 in FIGS. 1,2 and 3.

### DETAILED DESCRIPTION AND BEST MODE OF IMPLEMENTATION

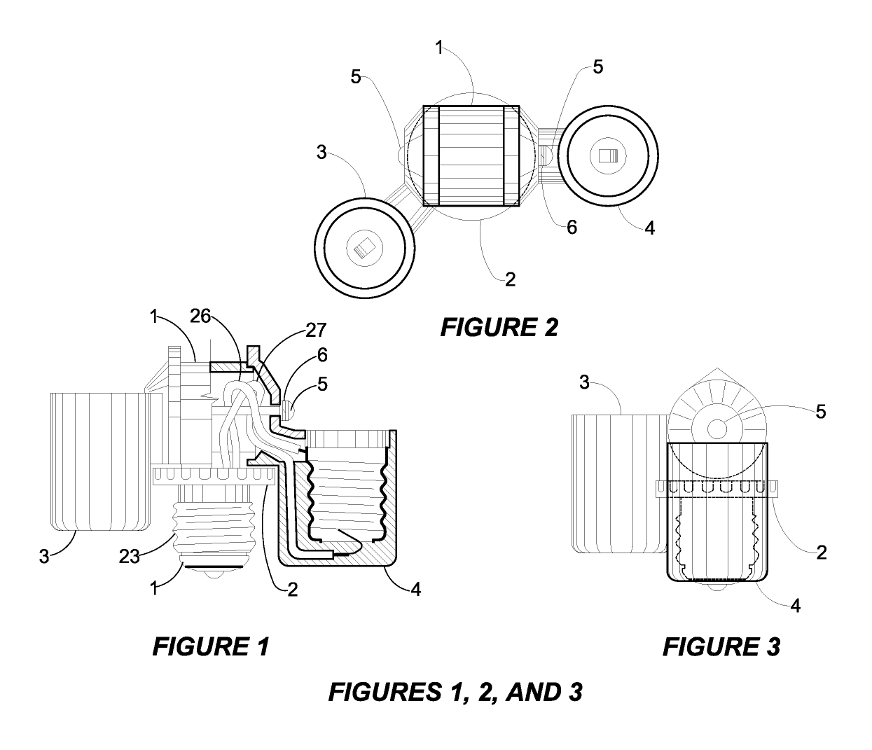

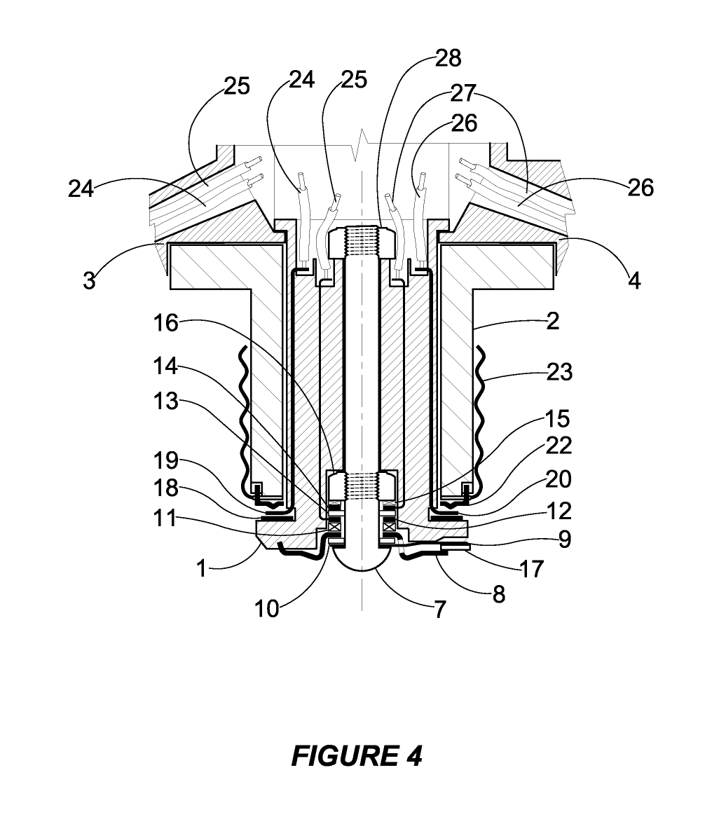

Refer to FIG. 1 and FIG. 4. Parts 1, 2, 3 and 4 are constructed of a suitable material having sufficient strength, endurance and electrical insulating properties to safely support metal conductors, light bulbs and metal connecting parts. These parts may be constructed of (and not limited to) ceramics, glass, thermoplastic polymer, thermoset polymer, phenolic, melamine, resinous and mixtures with inorganic materials.

Refer to FIGS. 1 and 3. FIG. 1 shows invention adapter in a side view with two bulb socket holders Parts 3 and 4 held in contact with Part 1 by pivot rod Part 5. Part 1 is a cylinder device part of the screw base containing metal electrical conductors and extends from the bottom up to top where the vertical axis is intersected by an integral horizontal cylinder device which provides circular provisions for a mechanism to allow independent rotation of each bulb socket holder in a plane parallel or nearly parallel to the vertical axis of Part 1. This partial cut away drawing displays insulated flexible metal conductors Parts 26 and 27 connecting the screw base electrical contacts with socket Part 4. FIG. 3 shows integral stops for limiting rotation of each bulb socket holder to restrict flexing of the connecting insulated flexible metal conductors Parts 24, 25, 26 and 27.

Refer to FIGS. 1, 2 and 3. These figures show two possible configurations of the bulb socket holders as Parts 3 and 4. The invention adapter could be produced containing two of matching bulb holders of either the type bulb holder Part 3 or bulb holder Part 4. The optimum arrangement is one that positions each of the two bulb socket holders as near as possible to the location of the adapter screw base with out interfering with safe operation of the two or three-position lamp holder socket intended for use therewith.

Refer to FIGS. 1 and 2. A spring loaded washer mechanism Part 6 is incorporated to provide a compression by pivot rod Part 5 on the attached connected parts and achieve resistance to rotation of each bulb socket holder Part 3 and Part 4. This feature eliminates the need for a locking device to secure bulb position after each rotation adjustment.

Refer to FIG. 4 showing the cross section drawing of the screw base consisting of Parts 1 and 2 assembled as cylinder shaped devices constructed of a suitable electrical insulating material having sufficient strength to safely support the two bulb adapter with light bulbs installed. Part 2 is a cylindrical element with an enlarged cylinder integral with the upper end and having the purpose of providing a finger grip or “thumb wheel” to rotate the screw base into and out of the receiving threaded socket of an existing lamp holder. Part 2, metal conductors Part 22 and Part 23 are combined and engaged as a unit to rotate freely around the inner Part 1. Part 2 is shaped to hold Part 1 captive to the adapter unit. Electrical connections are described below.

Refer to FIGS. 1 and 4. Part 1 contains metal electrical conductors to provide current channels from the screw base to the two separate bulb holders of the invention. Part 2 holds metal screw shell Part 23 which engages the three-way lamp holder or one-way lamp holder screw base socket and conducts the common current through screw shell Part 23 to metal ring Part 22 to metal collector foot Part 20 to insulated flexible metal conductor Part 26 to the common connection of bulb socket Part 4. Part 18 is a metal circular ring that serves as a combination conductor, wear ring and thrust washer against which metal collector foot Part 19 and collector foot Part 20 are restrained by Part 1. Collector foot Part 19 conducts the common connection to the common connection in bulb socket Part 3 using Parts 22, 23 and 24 in the same method described in the aforementioned for bulb socket Part 4. Metal center electrode Part 7 is secured to Part 1 by retaining nut Part 28 on the upper end. Center electrode Part 7 engages the center tap of of the three-way or the one-way lamp holder and conducts the hot current through metal tension nut Part 16 to metal lock washer Part 15 to metal ring Part 14 to metal conductor Part 27 to the center tap of socket Part 4. Insulating washer Part 13 provides electrical insulation between metal ring Part 14 and metal ring Part 12. Metal contacting ring Part 8 engages the intermediate connection in the three-way lamp holder socket and conducts the hot current to metal ring Part 11 to metal ring Part 12 to flexible metal conductor Part 25 to the center tap of socket Part 3. Insulating washer Part 10 provides electrical insulation between metal contacting ring Part 8 and metal adjustable shunt Part 9 which contacts center electrode Part 7.

Refer to FIG. 4. The following describes operation of the invention two bulb adapter installed in a traditional three-way lamp holder. Adjustable shunt Part 9 is a flexible metal device shown in contact with center electrode Part 7 and extending through an opening in contacting ring Part 8 that provides no contact between the two parts. Insulating plate Part 17 provides electrical insulation between adjustable shunt Part 9 and contacting ring Part 8. The position of the adjustable shunt Part 7 is determined before installing invention adapter and will be detailed later for another application. This aforementioned arrangement allows invention adapter to energize the two bulb sockets in the three-way manner, that is, switch position one (of the receiving lamp holder fixture) is off for both bulbs and switch position two lights bulb in socket Part 3 only and switch position three lights bulb in socket Part 4 only and switch position four lights both bulbs.

Refer to FIG. 4. The invention two bulb adapter permits operation when installed in a traditional two position on/off switched lamp holder normally used for a single filament light bulb. The invention contains an adjustable shunt Part 9 which is to be adjusted prior to installing invention into the receiving light bulb socket. Insulating plate Part 17 is hinge attached to Part 1 and manually swings out from the position shown as separating the adjustable shunt Part 9 and contacting ring Part 8. With insulating plate Part 17 moved out, adjustable shunt Part 9 is manually held against contacting ring Part 8 while insulating plate Part 17 is moved to be positioned on opposite side of the adjustable shunt Part 9. The insulating plate Part 17 when located at the “in” position to hold adjustable shunt Part 9 in contact with contacting ring Part 8 provides an electrical path between the center electrode Part 7 and the contacting ring Part 8. This allows current from the center contact electrode Part 9 to flow simultaneously to the center contacts of bulb sockets Parts 3 and 4. Thus both light bulbs are either simultaneously on or simultaneously off when operated with the traditional two position switched socket and with the adjustable shunt Part 9 properly positioned. The insulating plate Part 17 hinged design permits the invention two bulb adapter to be installed only when insulating plate Part 17 is in proper final adjustment position.

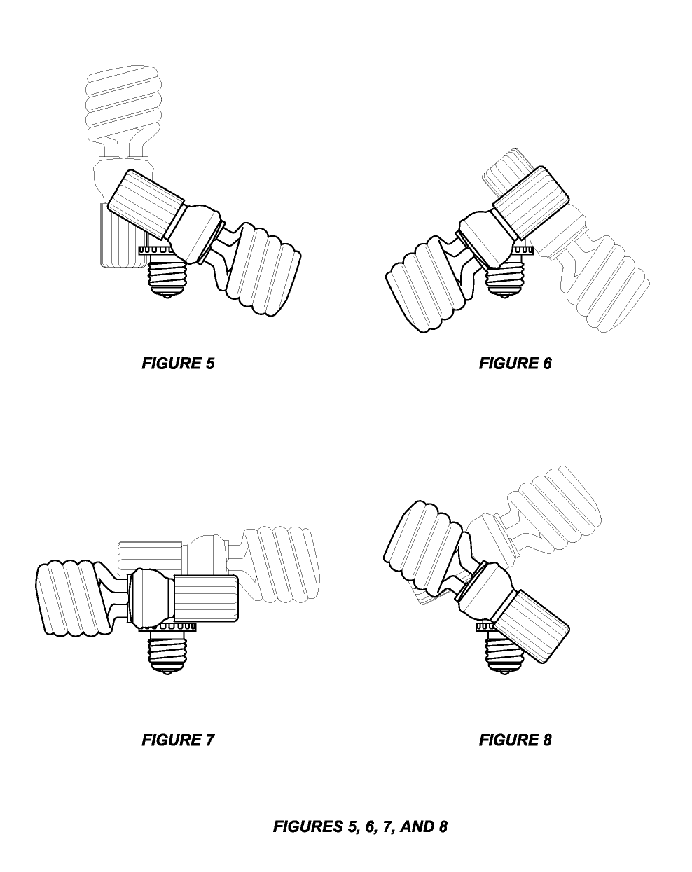

Refer to FIGS. 5, 6, 7 & 8. Each of these Figures display one of the positions of adapter bulb holders shown with installed CFL bulbs. Both bulb holders can be independently positioned to vertical or to any position from vertical to the respective below horizontal positions shown.

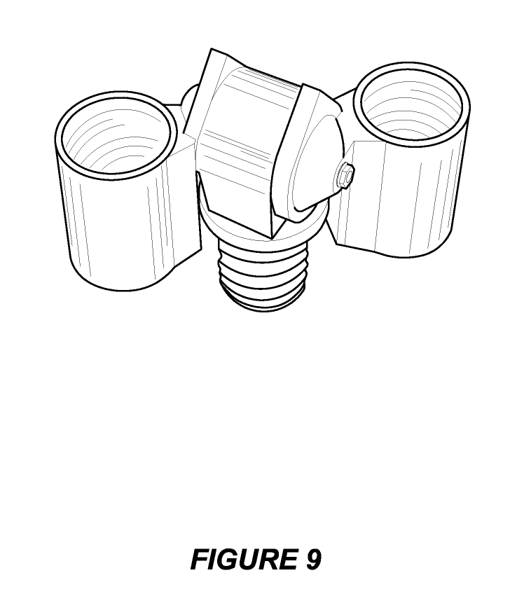

Refer to FIG. 9. This figure shows one of many possible configurations of the invention lamp adapter. The two opposed bulb holders shown are identical and similar to Part 3 shown on FIGS. 1,2 and 3. These bulb holders may be of any workable configuration and either matched or unmatched.

1. A two bulb holder lamp adapter with each holder separated for independent rotation in a plane parallel or nearly parallel to the axis of adapter's male screw base and closely positioned near the male screw base of said adapter.

2. A two bulb holder lamp adapter with a moveable shunt, contained in the male threaded base, for positioning current paths as a means to accommodate full function operation in a three-way or a single filament electric light lamp holder.

3. A two bulb holder adapter with a single male screw base fitted with electrically conducting metal collector rings and contactors to permit the invention lamp adapter to be installed into an existing lamp holder by turning an integral insulated “thumb wheel” attached to the conducting screw threads of the adapter base while holding adapter bulb holders in a non-revolving attitude.

4. A spring loaded device in the rotating mechanism of the two bulb holder lamp adapter to provide adequate compressive loading to enhance rotational resistance and permit bulb holders to be adjusted to and maintained in position without the need for a locking-unlocking device.
